(19) United States
(12) Patent Application Publication
(10) Pub. No.: US 2009/0109243 A1
(43) Pub. Date: Apr. 30, 2009

(54) APPARATUS AND METHOD FOR ZOOMING OBJECTS ON A DISPLAY

(75) Inventors: Christian Kraft, Frederiksberg C (DK); Peter Dam Nielsen, Kgs Lyngby (DK)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/924,084

(22) Filed: Oct. 25, 2007

(51) Int. Cl. G09G 5/00

(52) U.S. Cl. 345/660

(57) ABSTRACT

A method including determining a content area of a display including at least one content item to be scaled, presenting scaled content, corresponding to the at least one content item, in an scaled content area on the display, providing an indication of the scaled content area on the display and returning the scaled content to a previous size by selecting an area of the display that is outside the indicated scaled content area.

### BACKGROUND

1. Field

The disclosed embodiments generally relate to user interfaces and, more particularly, to displaying content on a display of a device.

2. Brief Description of Related Developments

The use of touch screen operated devices, such as mobile communication and other portable devices, is increasing. However, the displays on these touch screen devices are small in size and a portion of the content displayed on the screen is often enlarged or “zoomed” so that the content appears larger on the display. Generally content is zoomed on the touch screen devices by double-tapping an area of the screen or selecting a zoom tool (e.g. zoom keys or a cursor for selecting an area to zoom in on). The zoomed content may be reduced to its original size by re-tapping the screen. In some of the devices a user may zoom in on content by moving two fingers, that are in contact with the touch screen, together or apart.

When enlarging content on the displays of the touch screen devices some of the content may be cut off or missing when the content is enlarged as can be seen in FIGS. 1A and 1B (i.e. the user cannot see the entire content of a desired area).

It would be advantageous to be able to scale the size of content displayed on a device in an intuitive and easy way while the desired content is fitted to the screen.

### SUMMARY

In one aspect, the disclosed embodiments are directed to a method. In one embodiment the method includes determining a content area of a display including at least one content item to be scaled, presenting scaled content, corresponding to the at least one content item, in a scaled content area on the display, providing an indication of the scaled content area on the display and returning the scaled content to a previous size by selecting an area of the display that is outside the indicated scaled content area.

In another aspect, the disclosed embodiments are directed to an apparatus. In one embodiment the apparatus includes a processor and a display connected to the processor, wherein the processor is configured to determine a content area of the display including at least one content item to be scaled, present scaled content, corresponding to the at least one content item, in a scaled content area on the display, provide an indication of the scaled content area on the display and return the scaled content to a previous size in response to a selection of an area of the display that is outside the indicated scaled content area.

In yet another aspect, the disclosed embodiments are directed to a computer program product embodied in a memory of a device. In one embodiment the computer program product includes computer readable program code for causing a computer to determine a content area of the display including at least one content item to be scaled, computer readable program code for causing a computer to present scaled content, corresponding to the at least one content item, in a scaled content area on the display, computer readable program code for causing a computer to provide an indication of the scaled content area on the display and computer readable program code for causing a computer to return the scaled content to a previous size in response to a selection of an area of the display that is outside the indicated scaled content area.

In another aspect, the disclosed embodiments are directed to a user interface. The user interface includes an input configured to cause a selection of at least one content item to be scaled, a display configured to display the content item and a processor connected to the input and display, the processor being configured to determine a content area of the display including the at least one content item, present scaled content, corresponding to the at least one content item, in a scaled content area on the display, provide an indication of the scaled content area on the display and return the scaled content to a previous size in response to a selection of an area of the display that is outside the indicated scaled content area.

### BRIEF DESCRIPTION OF THE DRAWINGS

The foregoing aspects and other features of the embodiments are explained in the following description, taken in connection with the accompanying drawings, wherein:

FIGS. 1A and 1B illustrate screen shots of a prior art device;

FIG. 2 shows a block diagram of a system in which aspects of the disclosed embodiments may be applied;

FIGS. 3A-3C are illustrations of exemplary screen shots of a user interface in accordance with an aspect of the disclosed embodiments;

FIGS. 4A-4C are illustrations of exemplary screen shots of a user interface in accordance with an aspect of the disclosed embodiments;

FIG. 5 is a flow diagram in accordance with an aspect of the disclosed embodiments;

FIG. 6 illustrates schematic screen shots in accordance with an aspect of the disclosed embodiments;

FIGS. 7A and 7B are examples of devices that can be used to practice aspects of the disclosed embodiments;

FIG. 8 illustrates a block diagram of an exemplary system incorporating features that may be used to practice aspects of the disclosed embodiments; and

FIG. 9 is a block diagram illustrating the general architecture of an exemplary system in which the exemplary devices of FIGS. 7A and 7B may be used.

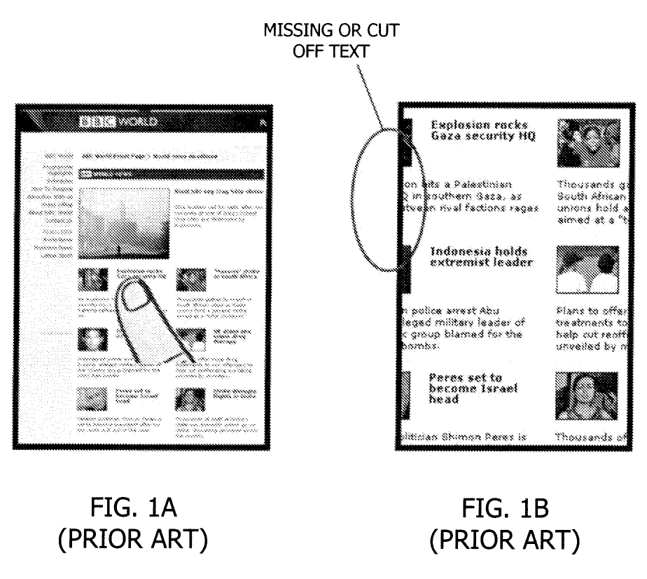

### DETAILED DESCRIPTION OF THE EMBODIMENT(s)

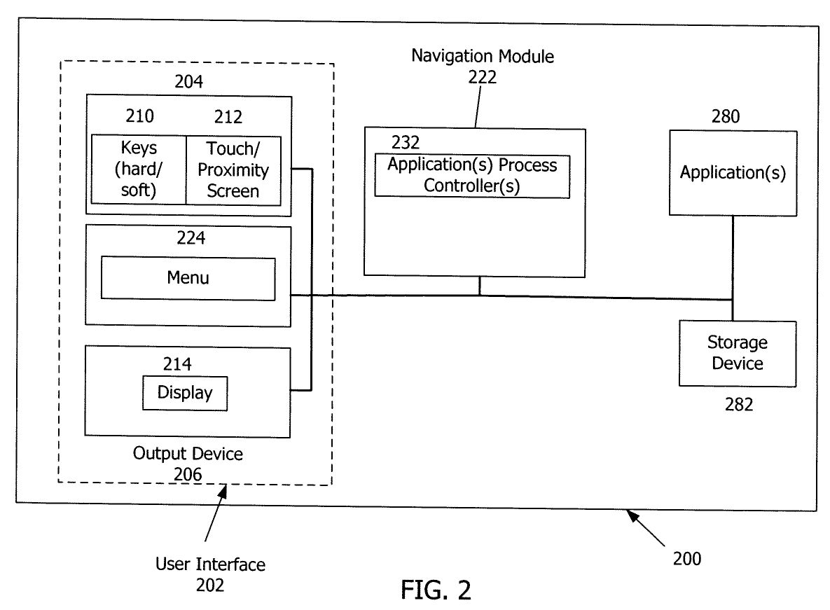

FIG. 2 illustrates one embodiment of a system 200 in which aspects of the disclosed embodiments can be used. Although aspects of the disclosed embodiments will be described with reference to the embodiments shown in the drawings and described below, it should be understood that these aspects could be embodied in many alternate forms. In addition, any suitable size, shape or type of elements or materials could be used.

The disclosed embodiments generally allow a user of a device or system, such as the system 200 shown in FIG. 2 to scale (i.e. “zoom in” or enlarge in size and “zoom out” or reduce in size to a previous or original size) the size of content displayed on the device in an intuitive and easy manner. The disclosed embodiments also allow a user of the system 200 to “zoom out” content that is already enlarged on the display. For example, if a user is viewing a web page where the system automatically fits the web page to the screen based on, for example, font size or a particular text area the disclosed embodiments may allow the user to zoom out or reduce the size of the web page as it appears on the display to get an overview of, for example the entire web page. As will be described in greater detail below the user may select content to be enlarged in any suitable manner so the enlarged content appears on the display. The user may reduce the selected content to its previous or original size by selecting an area of the display that is outside an area of the selected content.

In one embodiment, referring to FIG. 2, the system can include an input device 204, output device 206, navigation module 222, applications area 280 and storage/memory device 282. The components described herein are merely exemplary and are not intended to encompass all components that can be included in the system 200. For example, in one embodiment, the system 200 comprises a mobile communication device or other such Internet and application enabled devices. In one embodiment the applications of the device may include, but are not limited to, data acquisition (e.g. image, video and sound), multimedia players (e.g. video and music players), web or Internet browsers and picture viewers. Thus, in alternate embodiments, the system 200 can include other suitable devices and applications for monitoring application content and acquiring data and providing communication capabilities in such a device. While the input device 204 and output device 206 are shown as separate devices, in one embodiment, the input device 204 and output device 206 can be part of, and form, the user interface 202. The output device 206 may include any suitable output such as for example any suitable display 214.

The display 214 of the system 200 can comprise any suitable display including, but not limited to, a touch screen display, proximity screen device or graphical user interface. In one embodiment, the display 214 can be integral to the system 200. In alternate embodiments the display may be a peripheral display connected or coupled to the system 200. A pointing device, such as for example, a stylus, pen or simply the user's finger may be used with the display 214. In alternate embodiments any suitable pointing device may be used. In other alternate embodiments, the display may be any suitable display, such as for example a flat display 214 that is typically made of a liquid crystal display (LCD) with optional back lighting, such as a thin film transistor (TFT) matrix capable of displaying color images. A touch screen may be used instead of a conventional liquid crystal display. It is noted that the display 214 and touch/proximity screen 212 (hereinafter referred to as touch screen 212) may be incorporated into a single module such that the display 214 includes the touch screen 212 or the touch screen 212 may overlay the display 214.

The system 200 may also include other suitable features such as, for example, a camera, loudspeaker, connectivity port or tactile feedback features.

In one embodiment, the user interface of the disclosed embodiments can be implemented on or in a device that includes a touch screen display or a proximity screen device. In alternate embodiments, the aspects of the user interface disclosed herein could be embodied on any suitable device that will display information and allow the selection and activation of applications or system content. The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to encompass that a user only needs to be within the proximity of the device to carry out the desired function. For example, the term “touch” in the context of a proximity screen device, does not imply direct contact, but rather near or close contact, that activates the proximity device.

Similarly, the scope of the intended devices is not limited to single touch or contact devices. Multi-touch devices, where contact by one or more fingers or other pointing devices can navigate on and about the screen are also intended to be encompassed by the disclosed embodiments. Non-touch devices are also intended to be encompassed by the disclosed embodiments. Non-touch devices include, but are not limited to, devices without touch or proximity screens, where the navigation on and zooming of the content on the display is performed through, for example keys 210 of the system or through voice commands via a voice recognition feature of the system.

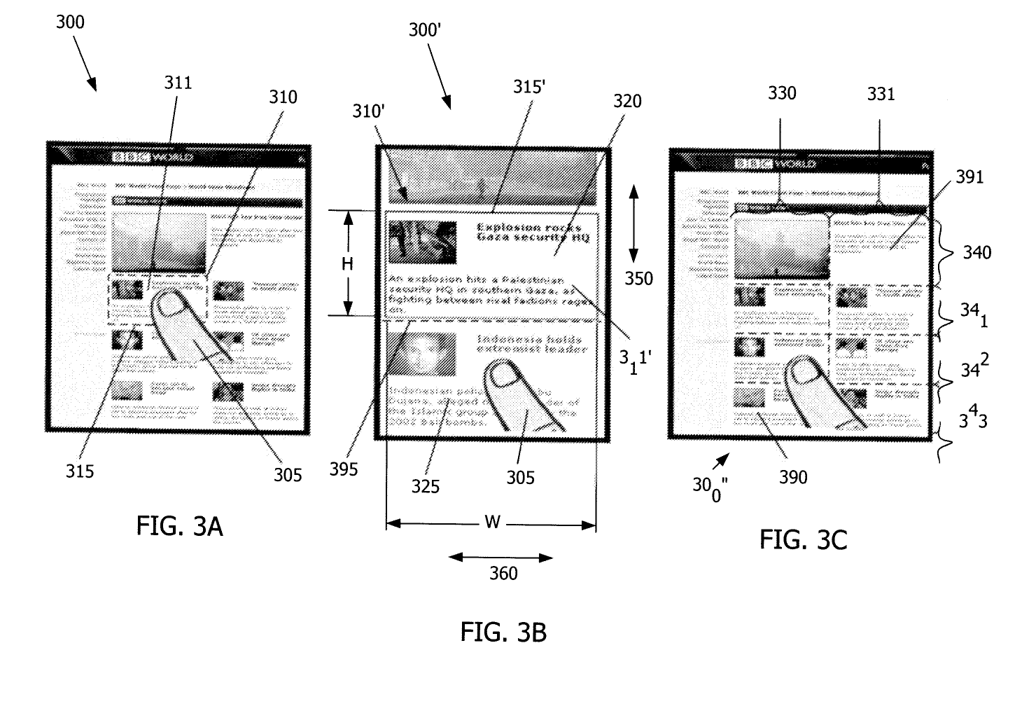

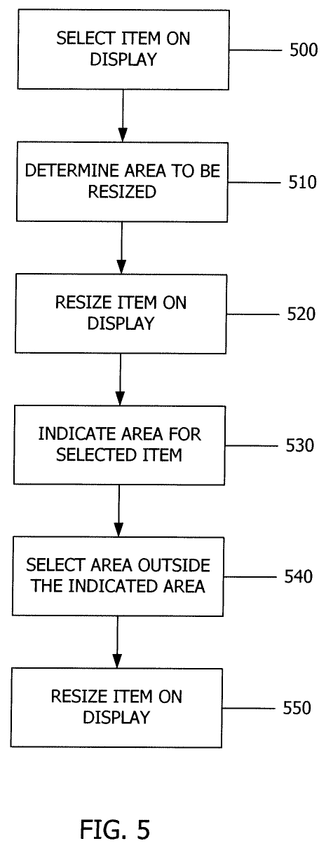

Referring now to FIGS. 3A-3C and also to FIG. 5, exemplary screen shots 300, 300′, 300″ that may be presented on the display 214 are shown. In this example, the screen shots 300′, 300′, 300″ show portions of a web page. It is noted that the web page is used to describe aspects of the disclosed embodiments for exemplary purposes only and in other embodiments any suitable content may be presented on the display for zooming including, but not limited to, spreadsheets, word processor documents, calendars, contact lists and other media content such as photographs, pictures and video. As can be seen in FIG. 3A a user may select a content item 311 from the web page to be enlarged or zoomed on the display 214. For exemplary purposes only, the content item 311 shown in FIG. 3A is a news caption but in other embodiments the content item may be any suitable content of the web page. The user may select the content item 311 using, for example, the touch screen 212 in any suitable manner including, but not limited to, any suitable pointing device or the user's finger 305 (as shown in the Figures). It is noted that while the disclosed embodiments are described herein with respect to the use of a touch screen, the disclosed embodiments are not limited to use with a touch screen. For example, in other embodiments the user may select the content item 311 in any suitable manner such as by using any suitable virtual pointer. The virtual pointer may be a cursor that is presented on the display 214 and controlled with any suitable input of the system 200 such as for example a multifunction key or a peripheral device (e.g. mouse or other device) connected to the system 200.

In this example, the user selects the content item by, for example, tapping the area of the touch screen 212 that corresponds to the content item 311 (FIG. 5, Block 500). Tapping (i.e. briefly touching) the touch screen 212 may include any suitable tapping method including, but not limited to, a single tap, a double tap, etc. The type of touch or tap used for selecting the content item 311 may be defined during manufacture of the device or set by the user using any suitable menu, such as menu 224. The system 200 is configured to detect or determine an area 310 that, for example, encompasses the selected object 311 (FIG. 5, Block 510). For exemplary purposes only, the system 200 may determine the area 310 by recognizing the different columns, rows and/or sections that, for example, a web page is generally divided into. Examples of these columns 330, 331 and rows 340-343 are shown in the exemplary screen shot 300″ of FIG. 3C. In other embodiments, the system 200 may be configured to recognize any suitable features of the displayed content when determining the area 310. For example, features of the hyper text markup language (HTML) source code including, but not limited to, floating or block elements such as the paragraph tag (<p>), the paragraph end tag (</p>), the generic division tag (<div>), the generic division end tag (</div>), the quoted text tag (<blockquote>) and the quoted text end tag (</blockquote>) or any combination thereof may be used in determining the area 310 of for example, a web page or any other document created with the hyper text markup language. In other embodiments features including, but not limited to, vertical and/or horizontal lines in the document, borders placed around objects in the document, frames, differences in text fonts and/or sizes, spacing between words and/or paragraphs, differences in colors or patterns, page breaks, section breaks and carriage return indicators may also be used in determining the area 310 to be zoomed in or out.

In other embodiments the system 200 can include any suitable content detection rules for defining the area 310. For exemplary purposes only, in one embodiment the system 200 may be configured to recognize images or pictures, several small images grouped closely together and paragraphs of text as a single area by the system. In other embodiments, the system 200 may be configured to recognize bright or dark portions of an image or picture (depending on which portion of the image or picture is selected by the user), individual ones of the closely grouped images, or individual words or sentences of a paragraph as the area to be enlarged on the display. In still other embodiments the system 200 may be configured to recognize any suitable feature of an item presented on the display 214 as the area 310.

In one embodiment, the system 200 may be configured to present to the user a preview of the determined area 310. The preview of the area 310 may be any suitable preview, such as for example, presenting a miniature version of the document on at least a portion of the display with, for example, a box or other indicator around the determined area 310. In other examples, the determined area may be highlighted on the display in any suitable manner including, but not limited to, changing a background color of the area 310, changing a brightness of the area 310, changing a font characteristic in the content in the area 310, presenting a border on the display around the area 310 and providing animation surrounding or pointing to the area 310.

In other embodiments, the system 200 may be configured to determine the area 310 and its content 311 in any suitable manner including, but not limited to, user defined areas. For example, the system 200 may be configured to allow a user to create a box 315 around the content to be zoomed by dragging a pointing device 305 across the touch screen 212 in, for example, a diagonal movement. In other embodiments the dragging movement may be any suitable movement across the touch screen 212. The box may be presented to the user as having phantom or dashed lines such as the box 315 shown in FIG. 3A. In other embodiments the box 315 may have an animated border that surrounds or points to content to be zoomed. In other embodiments the user defined box may be indicated in any suitable manner such as through any suitable highlighting such as changing a background color of the user defined area, changing a brightness of the user defined area, changing a font characteristic of the content in the user defined, presenting a border on the display around the area 310 and providing animation surrounding or pointing to the area 310. The system 200 may also be configured to allow the user to adjust an initial size of the box 315 by, for example selecting and moving a side or corner of the box where the box is resized as the sides or corner is moved. Once the desired content 311 is encompassed by the user-defined box, the user may zoom in on the content by tapping the area inside the box 311 in a manner substantially similar to that described above. The manner in which the system 200 determines the content area to be zoomed may be predefined during manufacture of the system 200 or defined by the user through any suitable menu 224 of the system 200.

In another embodiment, the user may move a pointing device in proximity of the screen 212 such that an area of a predetermined size follows the pointer on the display. This moving area indicates the area that would be zoomed if the area was selected. In one embodiment the area may be selected by tapping the screen 212 when the area is over a desired content of the display. In another embodiment the area may be selected by pressing a key of the device when the area is over the desired content. In still other embodiments the area may be moved around on the screen 212 using keys 210 of the device. In other embodiments the area that follows the pointing device may have any suitable size and may be resized in a manner substantially similar to that described above with respect to box 315. The size of the area that follows the pointer may be defined during manufacture of the system 200 or it may be settable by the user. It is noted that the movable area may have any of the characteristics described above with respect to the box 315 or the area 310.

Referring to FIG. 3B, the selected content 311 included in the area 310 is resized (i.e. enlarged or zoomed) on the display 214 (FIG. 5, Block 520). The zooming of the selected content 311 is an intelligent zooming in that the system 200 determines the height H and width W of the area 310 to be zoomed and then presents the zoomed area 310′ on the display 214 so that the entirety of the zoomed content 311′ can be seen by the user (e.g. the width and height are fit to the display such that the aspect ratio of the content 311 remains the same so the content is not distorted). In other embodiments, the zoomed area 310 may be presented so that the width W of the area 310 is fit to the display 214 where the user can scroll the zoomed content 311′ on the display 214 in the direction of arrow 350 (i.e. in a direction perpendicular to the width) in any suitable manner. In still other embodiments, the zoomed area 310 may be presented so that the height H of the area 310 is fit to the display 214 where the user can scroll the zoomed content 311′ on the display 214 in the direction of arrow 360 (i.e. move the contents in a direction perpendicular to the height) in any suitable manner. Scrolling the contents on the display 214 may include, but is not limited to, the use of a multifunction key of the system 200 or by dragging a pointing device 305 along the touch screen 212 in a predetermined scroll direction where the contents 311 move on the display along with the pointing device 305. It is noted that the scrolling of the zoomed content may be fixed with respect to the width or height of the content such that the content can only be scrolled along one axis (e.g. if the image is zoomed to fit the width the content can only be scrolled in a direction perpendicular to the fitted width).

In other embodiments the system 200 may be configured to automatically resize text and/or images within the zoomed in or zoomed out content if resizing the text and/or images would produce better zoom results (i.e. make the content easier to view). For example, if the zoomed area 310 includes a large image with a caption in a small font, when the area is zoomed in the caption may be enlarged more than the image so that the caption is easier to read. In another example, when zooming out, certain portions of the content area 310 may be reduced in size by larger amounts than other areas. This feature of partial zooming content within the zoomed content area 310 may present the content in a more proportional and efficient manner. In one embodiment, the system 200 may be configured such that the smaller the content (e.g. text and/or caption) the more zooming that is applied to that content. It is noted that the zooming may be greater than the height or width of the content as described above.

In one embodiment the system 200 may be configured to indicate to the user which content on the display 214 is the zoomed content 311′ (FIG. 5, Block 530). The indication may be any suitable indication including, but not limited to, highlighting (e.g. a background color change, a font characteristic change, providing animations surrounding or pointing to the zoomed content 311′, etc.) and a border around the content 311′. The indicator may be predefined during manufacture of the system 200 or settable by the user through any suitable menu 224. In the example shown in FIG. 3B the zoomed content 311′ is indicated by border 315′. The border may be any suitable border having any suitable characteristics such as those described above with respect to box 315. In other embodiments the indication may be configured so that it does not distract the user while the user is viewing the zoomed content 311′. The border 315′ (or any other suitable indicator) defines an interior portion 320 corresponding to the zoomed content area and an exterior portion 325 corresponding to an area outside the zoomed content area.

In this embodiment, the zoomed content 311′ can be reduced (e.g. zoomed “out”) to its previous or original size in any suitable manner. For example, the zoomed content 311′ may be reduced in size by tapping an area of the touch screen 212 corresponding to the exterior portion 325 (FIG. 5, Block 540). The tapping of the touch screen 212 to reduce the size of the zoomed content 311′ may be substantially similar to that described above with respect to selecting the content to be enlarged or zoomed. As can be seen in FIG. 3B, when the exterior portion 325 is selected the contents of, for example, the web page are resized on the display to their original or previous size (FIG. 5, Block 550). It is noted that the user may touch areas of the touch screen 212 corresponding to the interior portion 320 of the zoomed content without the content being resized which may allow the user to manipulate the content in any suitable manner. For example, an area of a photograph may be zoomed, edited and then returned to its previous or original size via a selection of an area outside the zoomed content area or interior portion 320.

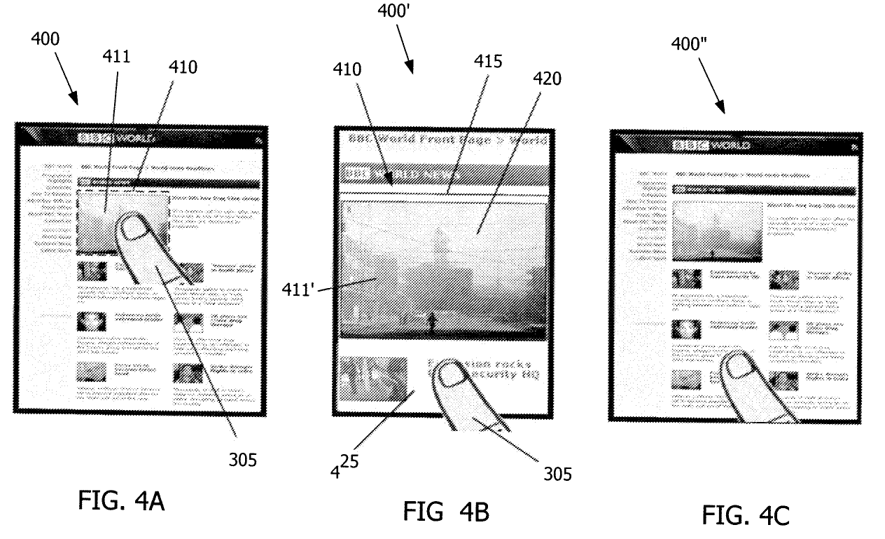

FIGS. 4A-4C illustrate another example of zooming content presented on the display 214. In this example the content is an image 411 as can be seen in screen shot 400. The user uses a pointing device 305 to select the image 411 as described above. The area 410 encompassing the image may be determined by the system 200 in a manner substantially similar to that described above. The image 411 is zoomed to fit the display as described above and shown in screen shot 400′. The display is divided into the zoomed portion 420 and an exterior portion 425 by, for example an indicator 415 that is substantially similar to indicator 315′ described above. The user may reduce the size of the zoomed content by selecting the exterior portion 425 so that the image 411 is returned to its previous or original size as described above and shown in screen shot 400″.

Referring back to FIG. 3B, in one embodiment, a user can select multiple areas of the display to be scaled. For example, the user may touch area 320 with one pointing device and area 325 with another pointing device (e.g. the user touches the display using, for example, two fingers). It is noted that in other embodiments, multiple areas of the display may be selected using, for example, any suitable keys of the system 200 in any suitable manner. In This embodiment, the system is configured to recognize both of the areas 320, 325 as being selected for scaling in a manner that is substantially similar to that described above such that both the selected areas are fit in the display. In other embodiments, any suitable number of areas may be selected for scaling. In another embodiment, if the user selects multiple areas that are separated from each other such as areas 390 and 391 in FIG. 3C, the system 200 may be configured to rearrange the display such that only the selected areas 390, 391 are scaled and displayed where the remainder of the original display content is hidden from view. For exemplary purposes only, the system 200 may “cut” each of the areas 390, 391 from, for example, the web page and present the two areas to the user in a different window, tab (e.g. where the browser display web pages in tabbed windows) or a new page on the display. In other embodiments the selected areas may be presented to the user in any suitable manner. In another embodiment, the system 200 may be configured to select multiple areas for scaling such as when the user selects a portion of the screen between two areas. For example, the user may touch the screen along line 395 in FIG. 3B. Because line 395 is between areas 320 and 325 the system 200 may determine that both areas 320, 325 are to be scaled in a manner substantially similar to that described above. In still another embodiment, the system 200 may be configured such that one of the selected areas such as area 320 may be selected for enlarging while the area 325 is selected to be reduced in size. For example, if there is an image that is substantially larger than the text associated with it the user may select the text for enlargement and the image for a reduction in size.

In another embodiment, the system 200 may be configured to allow a user to pan or scroll the scaled content on the display. For example, the system may be configured to distinguish between a touch for determining one or more scaled areas and a touch for scrolling or panning the displayed content. In one embodiment the touch for determining the scaled content may be defined by a predetermined time period where if the display is touched for less than the predetermined time period the selected content is scaled. If the screen is touched for a period longer than the predetermined time period the system 200 determines the displayed/scaled content is to be scrolled or panned. In one embodiment, the user may pan the displayed/scaled content by sliding a pointing device across the screen such that the displayed/scaled content moves along with the pointing device.

In other embodiments, the system 200 may be configured to pan or scroll the displayed/scaled content based on movement of the pointing device. For example, when the user touches the screen a predetermined area may be established around the pointing device. The area may have any suitable size. If during the touch the pointing device is moved outside the predetermined area, the system 200 will cause the displayed/scaled content to be panned or scrolled on the display. If during the touch the pointing device remains within the predetermined area the selected content will be scaled in size in a manner substantially similar to that described above. It is noted that the panning/scrolling of the displayed/scaled content as described above may occur when the interior portion 320 of the area to be scaled is selected and/or when the exterior area 325 is selected. In other embodiments any suitable keys of the system 200 may be used to scroll or pan the displayed/scaled content in any suitable manner.

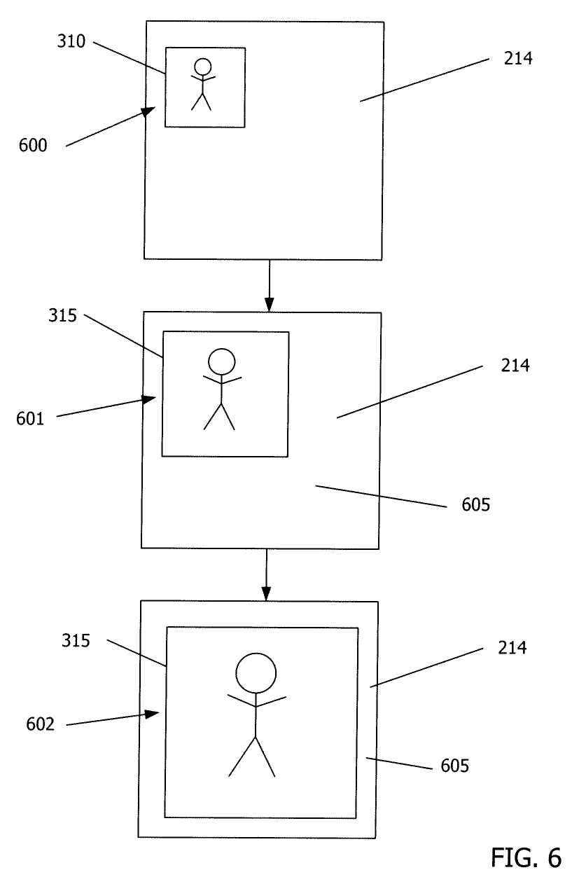

It is noted that in one embodiment the system 200 may include a menu 224 having user settable zooming features. For example, the user may be able to specify, using the menu, the degree of zooming of a selected content. For exemplary purposes only, there may be a setting so that the content is zoomed to fit the screen (the content is stretched in both width and height to fit the screen), zoomed to fit the width and height while preserving the original aspect ratio of the content as described above with respect to FIGS. 3A-3C, or zoomed to fit a width or height of the content to the screen (image size and/or font size) as also described above with respect to FIGS. 3A-3C and 4A-4C. In other embodiments the zooming level or degree of zooming can be specified in any suitable manner including, but not limited to, using for example any suitable controls of the system 200 such as for example, keys 210, a scroll wheel and using any suitable predetermined zoom factor. The predetermined zooming factor may be set during manufacture of the system or it may be user settable. There may also be a setting to define stages of zooming as can be seen in FIG. 6. For example, the user may tap the content to be zoomed a successive number of times where each time the content is tapped the size of the content increases by a predetermined amount. For example, the user may tap the touch screen 212 successively so that the content 600 is enlarged in steps (e.g. the zooming steps 601, 602) each time the touch screen in tapped. The size of the content may be reduced in a similar manner by successively tapping an exterior portion, such as exterior portion 325 in FIG. 3B so that the size of the content is reduced to its previous sizes (i.e. the previous zoom level) in successive steps. For example, a successive reduction in zoom level may be made from content 602 to content 600 by successively tapping a portion of the touch screen 212 corresponding to an area outside the zoomed content area (e.g. exterior portion 605). In one embodiment each stage of zooming in or out may have a different zooming factor. For example, the first stage of zooming in or out may have the greatest degree of zooming, the second stage of zooming may have a lesser degree of zooming and so on. In other embodiments each stage of zooming may have the same zooming factor. In still other embodiments each of the zooming stages may have any suitable zooming factors. The system may also be configured to recognize predetermined touch sequences or touch patterns to allow a user to return to a previous or original content size without having to successively reduce the image size.

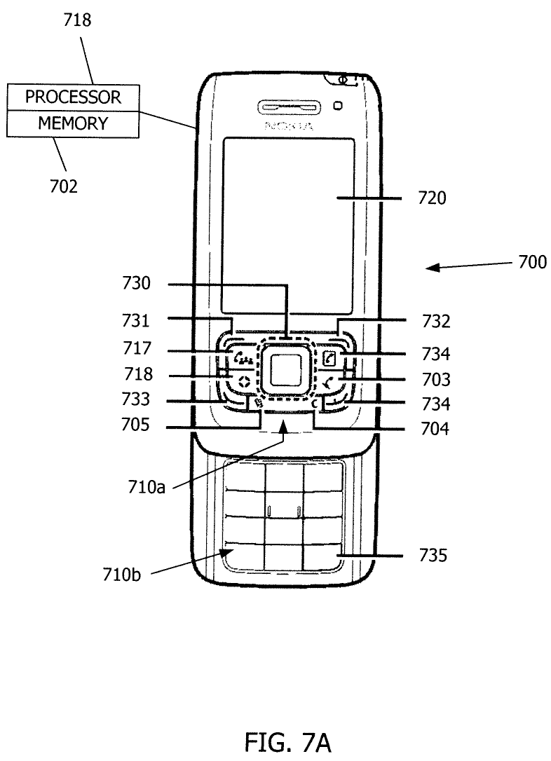

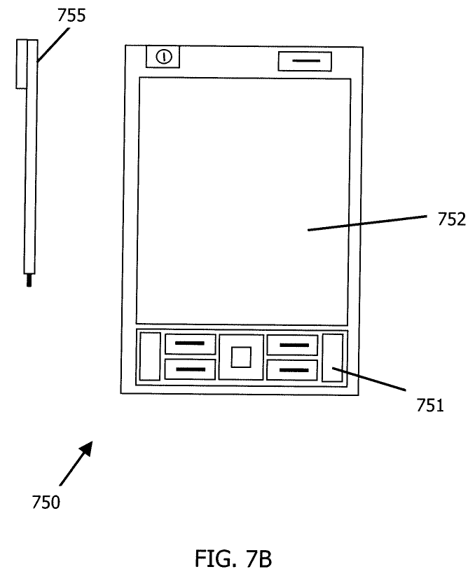

Examples of devices on which aspects of the disclosed embodiments can be practiced are illustrated with respect to FIGS. 7A and 7B. Although the embodiments are described as being implement on and with a mobile communication device, it will be understood that the disclosed embodiments can be practiced on any suitable device incorporating a display, processor, memory and supporting software or hardware. For example, in addition to the mobile communication device 700 and personal digital assistant 700′ described below, the device may be a navigation device, a personal communicator, a tablet computer, touch pad device, Internet tablet, a laptop or desktop computer, a multimedia device, a personal communicator, a television or television set top box, a digital video/versatile disk (DVD) or High Definition player, or any other suitable device capable of containing a display such as display 720′ and supported electronics such as a processor and memory.

In one example, the terminal or mobile communications device 700 may have one or more keypads 710a, 710b and a display 720. The keypad(s) 710a, 710b may include any suitable user input devices such as, for example, a multi-function/scroll key 730, soft keys 731, 732, a call key 733, an end call key 734, a contacts keys 734 for displaying user contacts, a mute key 703, a clear key 704, a menu key 705, a user definable key 718, a conference key 717, and alphanumeric keys 735. It is noted that the terminal or mobile communications device 700 is shown in FIG. 7A as a “slider” phone for exemplary purposes only. In other embodiments the device 700 may have any suitable configuration and/or key combinations. The display 720 may be any suitable display, such as for example, a touch screen display or graphical user interface. The display may be integral to the device 700 or the display may be a peripheral display connected to the device 700. A pointing device, such as for example, a stylus, pen or simply the user's finger may be used with the display 720. In alternate embodiments any suitable pointing device may be used. In other alternate embodiments, the display may be a conventional display. The device 700 may also include other suitable features such as, for example, a camera, loud speaker, connectivity port or tactile feedback features. The mobile communications device may have a processor 718 connected to the display for processing user inputs and displaying information on the display 720. A memory 702 may be connected to the processor 718 for storing any suitable information and/or applications associated with the mobile communications device 700 such as phone book entries, calendar entries, web browsers, etc.

In another embodiment, the system 200 of FIG. 2 may be for example, a personal digital assistant (PDA) style device 700′ illustrated in FIG. 7B. The personal digital assistant 700′ may have a keypad 710′, a touch screen display 720′ and a pointing device 750 for use on the touch screen display 720′.

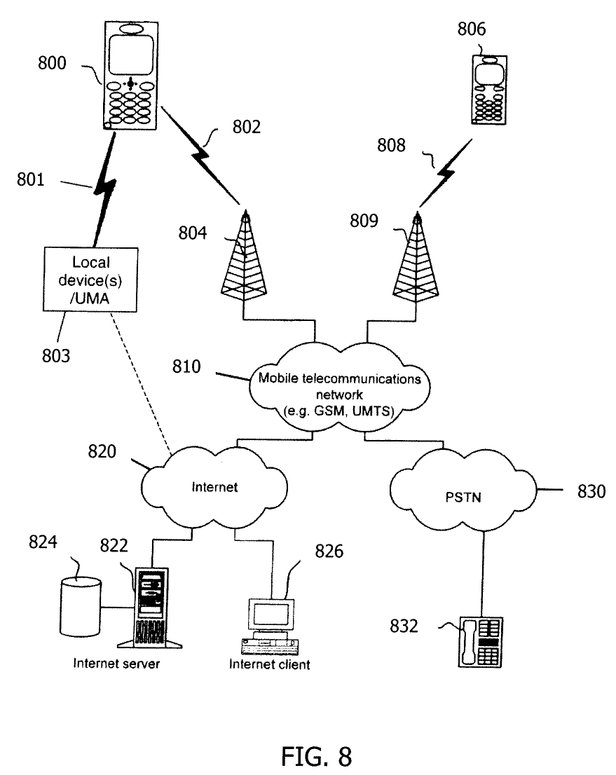

In the embodiment where the device 700, 700′ comprises a mobile communications device, the device can be adapted to communication in a telecommunication system, such as that shown in FIG. 8. In such a system, various telecommunications services such as cellular voice calls, worldwide web/wireless application protocol (www/wap) browsing, cellular video calls, data calls, facsimile transmissions, music transmissions, still image transmission, video transmissions, electronic message transmissions, electronic commerce and location determination/tracking may be performed between the mobile terminal 800 and other devices, such as another mobile terminal 806, a line telephone 832, a personal computer 851, or an internet server 822. It is to be noted that for different embodiments of the mobile terminal 800 and in different situations, some of the telecommunications services indicated above may or may not be available. The aspects of the disclosed embodiments are not limited to any particular set of services in this respect.

The mobile terminals 800, 806 may be connected to a mobile telecommunications network 810 through radio frequency (RF) links 802, 808 via base stations 804, 809. The mobile telecommunications network 810 may be in compliance with any commercially available mobile telecommunications standard such as for example global system for mobile communications (GSM), universal mobile telecommunication systems (UMTS), digital advanced mobile phone service (D-AMPS), code division multiple access 2000 (CDMA2000), wideband code division multiple access (WCDMA), wireless local area network (WLAN), freedom of mobile multimedia access (FOMA and time division-synchronous code division multiple access (TD-SCDMA). The mobile telecommunications network 810 may also be in compliance with any suitable network protocols including, but not limited to, transmission control protocol/Internet protocol (TCP/IP), X.25, asynchronous transfer mode (ATM), V34 and V90.

The mobile telecommunications network 810 may be operatively connected to a wide area network 820, which may be the Internet or a part thereof. An Internet server 822 has data storage 824 and is connected to the wide area network 820, as is an Internet client computer 826. The server 822 may host a worldwide web/wireless application protocol server capable of serving worldwide web/wireless application protocol content to the mobile terminal 800.

A public switched telephone network (PSTN) 830 may be connected to the mobile telecommunications network 810 in a familiar manner. Various telephone terminals, including the stationary telephone 832, may be connected to the public switched telephone network 830.

The mobile terminal 800 is also capable of communicating locally via a local link 801 or 851 to one or more local devices 803 or 850. The local links 801 or 851 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 803 can, for example, be various sensors that can communicate measurement values to the mobile terminal 800 over the local link 801. The above examples are not intended to be limiting, and any suitable type of link may be utilized. The local devices 803 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 800 may thus have multi-radio capability for connecting wirelessly using mobile communications network 810, wireless local area network or both. Communication with the mobile telecommunications network 810 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the navigation module 222 of FIG. 2 can include a communications module that is configured to interact with the system described with respect to FIG. 8.

The user interface 202 of FIG. 2 can also include menu systems 224 in the navigation module 222. The navigation module 222 provides for the control of certain processes of the system 200 including, but not limited to the zooming of display content as described herein. The menu system 224 can provide for the selection of different tools and application options related to the applications or programs running on the system 200. In one embodiment, the menu system 224 may provide for the selection of a zoom menu or features associated with the zooming of content as described above. In the embodiments disclosed herein, the navigation module 222 receives certain inputs, such as for example, signals, transmissions, instructions or commands related to the functions of the system 200, such as the zooming of display content. Depending on the inputs, the navigation module interprets the commands and directs the process control 232 to execute the commands accordingly.

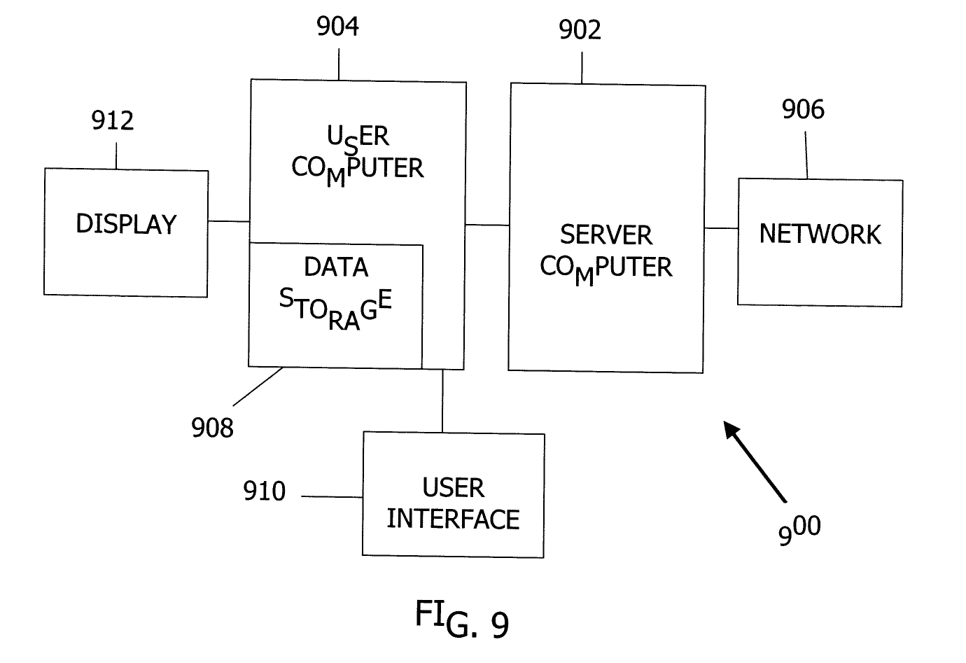

The disclosed embodiments may also include software and computer programs incorporating the process steps and instructions described above that are executed in different computers. FIG. 9 is a block diagram of one embodiment of a typical apparatus 900 incorporating features that may be used to practice aspects of the invention. The apparatus 900 can include computer readable program code means for carrying out and executing the process steps described herein. As shown, a computer system 902 may be linked to another computer system 904, such that the computers 902 and 904 are capable of sending information to each other and receiving information from each other. In one embodiment, computer system 902 could include a server computer adapted to communicate with a network 906. Computer systems 902 and 904 can be linked together in any conventional manner including, for example, a modem, wireless, hard wire connection, or fiber optic link. Generally, information can be made available to both computer systems 902 and 904 using a communication protocol typically sent over a communication channel or through a dial-up connection on an integrated services digital network (ISDN) line. Computers 902 and 904 are generally adapted to utilize program storage devices embodying machine-readable program source code, which is adapted to cause the computers 902 and 904 to perform the method steps, disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips and universal serial bus devices (e.g. memory sticks and thumb drives).

Computer systems 902 and 904 may also include a microprocessor for executing stored programs. Computer 902 may include a data storage device 908 on its program storage device for the storage of information and data. The computer program or software incorporating the processes and method steps incorporating aspects of the invention may be stored in one or more computers 902 and 904 on an otherwise conventional program storage device such as those described above. In one embodiment, computers 902 and 904 may include a user interface 910, and a display interface 912 from which aspects of the invention can be accessed. The user interface 910 and the display interface 912 can be adapted to allow the input of queries and commands to the system, as well as present the results of the commands and queries.

The embodiments described herein allow a user to zoom in or zoom out content presented on a display in an easy and intuitive manner. The user is able to manipulate the zoomed content in any suitable manner using, for example, the touch screen without reducing the size of the content. To return the zoomed content to its previous or original size the user can activate an area of the touch screen that corresponds to an area outside the indicated zoomed area. It is noted that the embodiments described herein may be used separately or in any combination thereof.

It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
determining a content area of a display including at least one content item to be scaled;
presenting scaled content, corresponding to the at least one content item, in a scaled content area on the display;
providing an indication of the scaled content area on the display; and
returning the scaled content to a previous size by selecting an area of the display that is outside the indicated scaled content area.

2. The method of claim 1, wherein presenting the scaled content on the display comprises resizing the at least one content item so a width or height of the at least one content item is fit to the display.

3. The method of claim 1, wherein the content area of a display including at least one content item to be scaled is determined through hyper text markup language source code features including one or more of paragraph tags, paragraph end tags, generic division tags, generic division end tags, quoted text tags and quoted text end tags.

4. The method of claim 1, wherein determining the content area includes selecting the at least one content item.

5. The method of claim 4, wherein selecting the at least one content item includes touching an area of a touch screen corresponding to the at least one content item.

6. The method of claim 1 wherein, selecting the area of the display that is outside the scaled content area includes touching an area of a touch screen corresponding to the area of the display that is outside the scaled content area.

7. The method of claim 1, wherein presenting the scaled content comprises enlarging the at least one content item to be scaled.

8. An apparatus comprising:
a processor; and
a display connected to the processor;
wherein the processor is configured to:
determine a content area of the display including at least one content item to be scaled;
present scaled content, corresponding to the at least one content item, in a scaled content area on the display;
provide an indication of the scaled content area on the display; and
return the scaled content to a previous size in response to a selection of an area of the display that is outside the indicated scaled content area.

9. The apparatus of claim 8, wherein the processor is further configured to scaled the at least one content item so a width and height of the at least one content item is fit to the display.

10. The apparatus of claim 8, wherein the processor is further configured to determine the scaled content area through hyper text markup language source code features including one or more of paragraph tags, paragraph end tags, generic division tags, generic division end tags, quoted text tags and quoted text end tags.

11. The apparatus of claim 8, wherein the processor is further configured to determine the content area in response to a selection of the at least one content item on a touch screen of the apparatus.

12. The apparatus of claim 8, wherein the processor is further configured to reduce the scaled content in response to a selection of an area of a touch screen of the apparatus corresponding to the area of the display that is outside the scaled content area.

13. The apparatus of claim 8, wherein the apparatus is a mobile communication device.

14. The apparatus of claim 8, wherein the processor is configured to enlarge the at least one content item to be scaled.

15. A computer program product embodied in a memory of a device comprising:
computer readable program code for causing a computer to determine a content area of the display including at least one content item to be scaled;
computer readable program code for causing a computer to present scaled content, corresponding to the at least one content item, in an scaled content area on the display;
computer readable program code for causing a computer to provide an indication of the scaled content area on the display; and
computer readable program code for causing a computer to return the scaled content to a previous size in response to a selection of an area of the display that is outside the indicated scaled content area.

16. The computer program product of claim 13, wherein the scaled content area is determined through hyper text markup language source code features including one or more of paragraph tags, paragraph end tags, generic division tags, generic division end tags, quoted text tags and quoted text end tags.

17. The computer program product of claim 13, wherein the content area is determined in response to a selection of the at least one content item on a touch screen of the computer.

18. A user interface comprising:
an input configured to cause a selection of at least one content item to be scaled;
a display configured to display the content item; and
a processor connected to the input and display, the processor being configured to:
determine a content area of the display including the at least one content item;
present scaled content, corresponding to the at least one content item, in an scaled content area on the display;
provide an indication of the scaled content area on the display; and
return the scaled content to a previous size in response to a selection of an area of the display that is outside the indicated scaled content area.

19. The user interface of claim 18, wherein the processor is further configured to enlarge the at least one content.

20. The user interface of claim 18, wherein the processor is further configured to determine the scaled content area through hyper text markup language source code features including one or more of paragraph tags, paragraph end tags, generic division tags, generic division end tags, quoted text tags and quoted text end tags.
